(19) United States
(12) Patent Application Publication
(10) Pub. No.: US 2014/0081727 A1
(43) Pub. Date: Mar. 20, 2014

(54) Methods And Systems For Redeeming Loyalty Rewards

(71) Applicant: Total Systems Services, Inc., Columbus, GA (US)

(72) Inventors: Robert David Hoffmire, Newnan, GA (US); Nancy Alderman Crace, Cumming, GA (US); Daniel Burke, Alpharetta, GA (US); Kevin J. Smith, Johns Creek, GA (US); Lou An Yu, Smyrna, GA (US)

(21) Appl. No.: 14/031,597

(22) Filed: Sep. 19, 2013

Related U.S. Application Data
(60) Provisional application No. 61/702,907, filed on Sep. 19, 2012.

(51) Int. Cl. G06Q 30/02

(52) U.S. Cl. CPC G06Q 30/0233
USPC 705/14.17

(57) ABSTRACT

Methods and systems can be provide for redeeming loyalty rewards such as loyalty points for value. In an aspect, an input can be received. The input can relate to a loyalty program and a user account. The input can comprise an exchangeable value and the user account has a profile associated therewith. The input can be analyzed to automatically determine a modification to the profile based upon the exchangeable value. The modification can be applied to the profile associated with the user account.

### CROSS REFERENCE TO RELATED PATENT APPLICATION

This application claims priority to U.S. Provisional Application No. 61/702,907 filed Sep. 19, 2012, herein incorporated by reference in its entirety.

### BACKGROUND

Loyalty programs can be implemented to encourage consumers to make certain purchases and/or to patronize certain providers by virtue of the loyalty incentives offered to them for making those purchases via those providers. As an example, a financial institution can provide loyalty incentives each time a consumer uses a credit card associated with the financial institution. Certain benefits to the financial institution include increased repeat business and an improved understanding of the preferences and behavior of their customer. The benefits to the consumers include the ability to redeem their accumulated incentives for various bonuses and premiums. The quantity of loyalty incentives are expressed to consumers in non-monetary terms such as “points” and “air-miles.” By not identifying loyalty incentives as having explicit monetary values to consumers, merchants gain considerable freedom in using the loyalty incentives in their business. However, there is a continued need to provide unique value to consumers for accumulated loyalty incentives. These and other shortcomings of the art are addressed by the present disclosure.

### SUMMARY

It is to be understood that both the following general description and the following detailed description are exemplary and explanatory only and are not restrictive, as claimed. Provided are methods and systems for redeeming loyalty rewards such as loyalty points for value. In an aspect, loyalty rewards can be associated with an exchangeable value. In a further aspect, the exchangeable value can be expressed in terms of a modification (e.g., increase or decrease) in an account profile associated with the loyalty rewards. For example, loyalty rewards can be exchanged for a decrease in an interest rate associated with a credit account. As another example, the loyalty rewards can be exchanged for an increase in an interest rate associated with an investment account. As a further example, the loyalty rewards can be exchanged for a modification to a billing cycle, a deferment of payment, and/or a forbearance of payment.

In an aspect, a data management system can comprise a user interface configured to receive an input, wherein the input comprises an exchangeable value associated with a loyalty program and a user account. The system can comprise a processor in communication with the user interface to receive the input therefrom, the processor configured to analyze the input based upon an instruction set and to generate feedback in response to the analysis of the input, wherein the feedback comprises a modification in an interest rate associated with the user account.

In an aspect, a method for redeeming loyalty for value can comprise receiving an input relating to a loyalty program and a user account, wherein the input comprises an exchangeable value. The input can be analyzed based upon an instruction set, wherein the instruction set comprises processor executable instructions for automatically determining a modification in interest rate based upon the exchangeable value. The modification can be applied in interest rate to a current interest rate associated with the user account.

In an aspect, a method can comprise receiving first information relating to a credit account associated with a user, wherein the credit account has an interest rate associated therewith. A first maximum liability can be determined based on the first information and a first fixed modification of the interest rate associated with the credit account. A first exchangeable value can be determined. The first exchangeable value can relate to a loyalty program based on the first maximum liability, wherein the first exchangeable value is redeemable to facilitate the application of the first fixed modification to the interest rate associated with the credit account.

In an aspect, a method for redeeming loyalty for value can comprise receiving an input relating to a loyalty program and a user account, wherein the input comprises an exchangeable value and the user account has a profile associated therewith. The input can be analyzed based upon an instruction set, wherein the instruction set comprises processor executable instructions for automatically determining a modification to the profile based upon the exchangeable value. The modification can be applied to the profile associated with the user account.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram of an example system;

FIG. 2 is flow diagram of an example method;

FIG. 3 is flow diagram of an example method;

FIG. 4 is flow diagram of an example method;

FIG. 5A is flow diagram of an example method;

FIG. 5B is a representation of an example user interface;

FIG. 6 is flow diagram of an example method;

FIG. 7 is flow diagram of an example method; and

FIG. 8 is a block diagram of an example computing system.

### DETAILED DESCRIPTION

Before the present methods and systems are disclosed and described, it is to be understood that the methods and systems are not limited to specific methods, specific components, or to particular compositions. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

In one aspect of the disclosure, methods and systems are provided for redeeming loyalty rewards such as loyalty points for value. In an aspect, loyalty rewards can be associated with an exchangeable value. In a further aspect, the exchangeable value can be expressed in terms of a modification (e.g., increase or decrease) in an account profile associated with the loyalty rewards. For example, loyalty rewards can be exchanged for a decrease in an interest rate associated with a credit account. As another example, the loyalty rewards can be exchanged for an increase in an interest rate associated with an investment account. As a further example, the loyalty rewards can be exchanged for a modification to a billing cycle, a deferment of payment, and/or a forbearance of payment. Other aspects of an account profile or account can be modified in exchange for loyalty rewards. For example, service level upgrades, expedited processing, reduced fees, and the like can be applied in exchange for a particular value associated with loyalty rewards. In an aspect, a user interface can be provided to allow a user to redeem loyalty rewards.

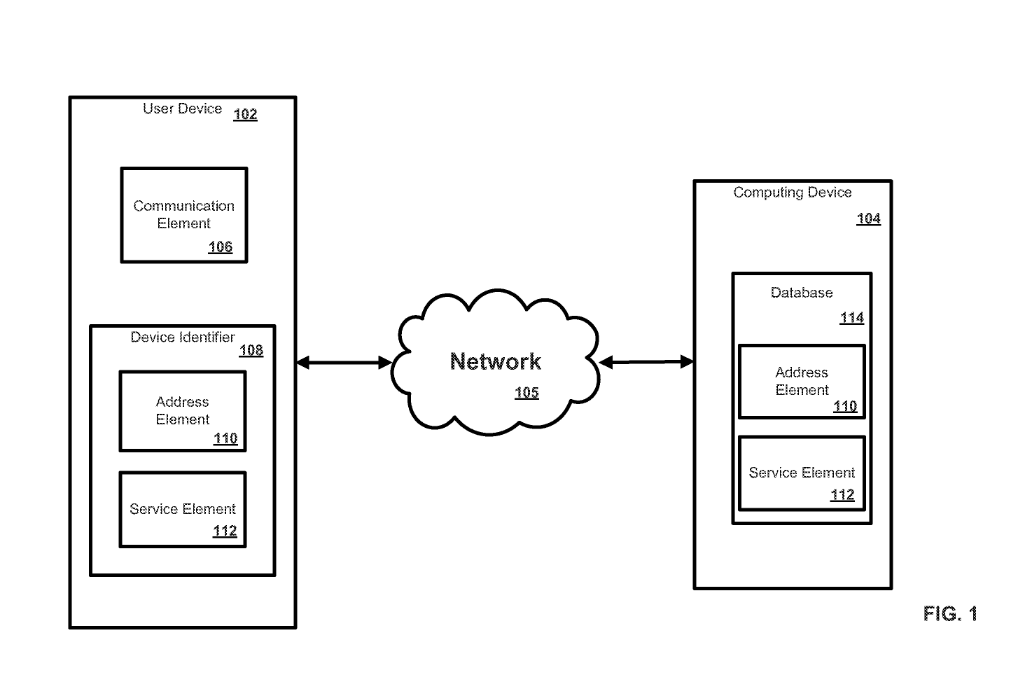

As shown in FIG. 1, a network and system can comprise a user device 102 in communication with a computing device 104 such as a server, for example. The computing device 104 can be disposed locally or remotely relative to the user device 102. As an example, the user device 102 and the computing device 104 can be in communication via a private and/or public network 105 such as the Internet or a local area network. Other forms of communications can be used such as wired and wireless telecommunication channels, for example.

In an aspect, the user device 102 can be an electronic device such as a computer, a smartphone, a laptop, a tablet, a set top box, a display device, or other device capable of communicating with the computing device 104. As an example, the user device 102 can comprise a communication element 106 for providing an interface to a user to interact with the user device 102 and/or the computing device 104. The communication element 106 can be any interface for presenting and/or receiving information to/from the user, such as user feedback. An example interface may be communication interface such as a web browser (e.g., Internet Explorer, Mozilla Firefox, Google Chrome, Safari, or the like). Other software, hardware, and/or interfaces can be used to provide communication between the user and one or more of the user device 102 and the computing device 104. As an example, the communication element 106 can request or query various files from a local source and/or a remote source. As a further example, the communication element 106 can transmit data to a local or remote device such as the computing device 104.

In an aspect, the communication element 106 (e.g., user interface, graphical user interface, etc.) can be configured receive an input such as a selection from a user. In another aspect, the input can comprise an exchangeable value associated with a loyalty program and a user account. As an example, the exchangeable value can comprise one or more loyalty rewards (e.g., a quantity of rewards) such as points. In an aspect, the user account can be associated with a provider associated with the loyalty program. As an example, the provider can be a financial institution, merchant, vendor, and/or service provider. As a further example, a third party to the provider can implement the loyalty program on behalf of the provider.

In an aspect, a processor can be in communication with the communication element 106 to receive the input therefrom. As an example, the processor can be the user device 102 and/or the computing device 104. In another aspect, the processor can be configured to analyze the input based upon an instruction set. As an example, the processor can generate feedback in response to the analysis of the input. The feedback can comprise a modification (e.g., increase, decrease, etc.) in an interest rate associated with the user account. Such modification can be applied for a fixed period of time, periodically applied, or continuously applied. As another example, the instruction set can comprise processor executable instructions for automatically retrieving a modification in the interest rate based on the exchangeable value. Such modifications can be stored in a table associating fixed modification with fixed value amounts or ranges. As another example, the instruction set can comprise processor executable instructions for automatically calculating a modification in the interest rate based upon a credit limit associated with the user account. As a further example, the instruction set comprises processor executable instructions for automatically calculating a modification in the interest rate based upon a liability to a provider associated with the user account. The provider can be a financial provider.

In an aspect, the user device 102 can be associated with a user identifier and/or device identifier 108. As an example, the device identifier 108 can be any identifier, token, character, string, or the like, for differentiating one user or user device (e.g., user device 102) from another user or user device. In a further aspect, the device identifier 108 can identify a user or user device as belonging to a particular class of users or user devices. As a further example, the device identifier 108 can comprise information relating to the user device such as a manufacturer, a model or type of device, a service provider associated with the user device 102, a state of the user device 102, a locator, and/or a label or classifier. Other information can be represented by the device identifier 108.

In an aspect, the device identifier 108 can comprise an address element 110 and a service element 112. In an aspect, the address element 110 can comprise or provide an internet protocol address, a network address, a media access control (MAC) address, an Internet address, or the like. As an example, the address element 110 can be relied upon to establish a communication session between the user device 102 and the computing device 104 or other devices and/or networks. As a further example, the address element 110 can be used as an identifier or locator of the user device 102. In an aspect, the address element 110 can be persistent for a particular network.

In an aspect, the service element 112 can comprise an identification of a service provider associated with the user device 102 and/or with the class of user device 102. The class of the user device 102 can be related to a type of device, capability of device, type of service being provided, and/or a level of service (e.g., business class, service tier, service package, etc.). As an example, the service element 112 can comprise information relating to or provided by a communication service provider (e.g., Internet service provider) that is providing or enabling data flow such as communication services to the user device 102. As a further example, the service element 112 can comprise information relating to a preferred service provider for one or more particular services relating to the user device 102. In an aspect, the address element 110 can be used to identify or retrieve data from the service element 112, or vice versa. As a further example, one or more of the address element 110 and the service element 112 can be stored remotely from the user device 102 and retrieved by one or more devices such as the user device 102 and the computing device 104. Other information can be represented by the service element 112.

In an aspect, the computing device 104 can be a server for communicating with the user device 102. As an example, the computing device 104 can communicate with the user device 102 for providing data and/or services. As an example, the computing device 104 can provide services such as network (e.g., Internet) connectivity, financial services, e-commerce, and the like.

In an aspect, the computing device 104 can manage the communication between the user device 102 and a database 114 for sending and receiving data therebetween. As an example, the database 114 can store a plurality of files (e.g., web pages), user identifiers or records, or other information such as account information. As a further example, the user device 102 can request and/or retrieve a file from the database 114. In an aspect, the database 114 can store information relating to the user device 102 such as the address element 110 and/or the service element 112. As an example, the computing device 104 can obtain the device identifier 108 from the user device 102 and retrieve information from the database 114 such as the address element 110 and/or the service elements 112. As a further example, the computing device 104 can obtain the address element 110 from the user device 102 and can retrieve the service element 112 from the database 114, or vice versa. Any information can be stored in and retrieved from the database 114. The database 114 can be disposed remotely from the computing device 104 and accessed via direct or indirect connection. The database 114 can be integrated with the computing system 104 or some other device or system.

In an aspect, a loyalty program can associate a redeemable item (e.g., reward, points) with a particular exchangeable value. As an example, when a user of a loyalty program has a requisite amount of redeemable items, the user can exchange the redeemable items to cause a modification in an attribute associated with a profile. The profile can be associated with an account such as a financial account (e.g. credit account, investment account, bank account, etc.). As an example, the profile can comprise one or more of a payment cycle, an interest rate, a due date, deferred payment window, and payment forbearance window. As a further example, the modification can comprise an increase or decrease in one or more of a payment cycle, an interest rate, a due date, deferred payment window, and payment forbearance window. Other modifications can be made to other parameters associated with the user and/or the user account. Such a modification can be applied for a fixed period of time.

In an aspect, the redeemable item(s) can be exchanged for value in the form of a modification to an interest rate. In another aspect, each of a configurable number of interest rate reductions (e.g. 2%, 5%, 10%, etc.) can be associated with a particular exchangeable value (e.g., 6000 points, 12500 points, 25000 points, etc.). In a further aspect, once the redeemable item(s) are exchanged, a credit card annual percentage rate (APR) associated with the user can be reduced by the interest rate reduction associated with the amount of exchangeable value tendered. In a further aspect, the reduction of the credit card annual percentage rate can be applied for a particular amount of time. As an example, a reduction in interest can be associated with different exchangeable values based upon an amount of time (e.g., 1 year, 6 months, etc.).

In an aspect, a cost to the provider of the credit card can be calculated using the user's credit limit. As an example, a 5% reduction in interest for one year on an account having a $10,000 credit limit can have a maximum cost of $500.00. As a further, example, the cost associated with the reduction in interest can assume that the user maintains 100% of their credit limit for an entire year, which is the maximum cost to the bank or financial institution. As such, if the user does not maintain 100% of their credit limit for the reduction time period, the cost to the provider will be less than the calculated maximum. In an aspect, the credit limit can be locked during the reduction of interest time period to ensure the maximum liability is not changed. Also the provider may want the ability to limit how many times an APR discount could be redeemed for by one user (e.g., card member). The provider may also want to limit who is eligible for redemption and may want to exclude certain segments of their user (e.g., card member) population. As such, the number of redemptions of a particular redeemable item can be limited or can be openly applied. When multiple redeemable items are exchanged for a single account, the modification to the account can be compounded, applied in parallel, and/or sequenced.

As an example, Tables A-C illustrate an analysis of exchanging loyalty rewards (points) for a reduction in APR. Such analysis can consider factors comprising credit limit, an amount of APR reduction, gross cost per loyalty point (CPP), average use percentage (%) of credit limit, interest on prepaid value, reduction term, maximum liability, associated cost in reward points, effective CPP, net cost, and cost savings, for example.

TABLE A
APR Discount Offer Analysis

| | Tier 1 | | |
|---|---|---|---|
| Credit Limit | $2,500 | $5,000 | $10,000 |
| APR Reduction | 2.5% | 2.5% | 2.5% |
| Gross CPP | 0.01 | 0.01 | 0.01 |
| Average % of credit limit | 85% | 85% | 85% |
| Interest on Prepaid Interest | 3% | 3% | 3% |
| Reduction Term (Months) | 3 | 3 | 3 |
| Max Liability | $15.63 | $31.25 | $62.50 |
| Cost in Points | 1,563 | 3,125 | 6,250 |
| Effective CPP | 0.0085 | 0.0085 | 0.0085 |
| Net Cost | $13.22 | $26.44 | $52.88 |
| Cost savings | $2.40 | $4.81 | $9.62 |

In Table A, an APR reduction of 2.5% for a term of 3 months can be categorized as a Tier 1 option for potential exchange. As shown, the Tier 1 option can be applied (actually or for estimation) to a plurality of user accounts having different credit limits associated therewith. For example, applying Tier 1 to a credit limit of $2,500 results in a maximum liability of about $15.63 (2.5%*2500*(3/12 months)=$15.63). Assuming a CPP of 0.01, the application of Tier one to an account with a $2500 credit limit can be valued at 1563 points ($15.63/0.01=1563). Applying the same principles to an account with a credit limit of $5000 results in a valuation of 3125 points. Applying the same principles to an account with a credit limit of $10000 results in a valuation of 6250 points. However, the user of a particular account may only use an average of 85% of the credit limit. As such, the effective CPP could be 0.0085 rather than 0.01, thereby reducing the net cost to the provider of the reduction in APR.

TABLE B
APR Discount Offer Analysis

| | Tier 2 | | |
|---|---|---|---|
| Credit Limit | $2,500 | $5,000 | $10,000 |
| APR Reduction | 5% | 5% | 5% |
| Gross CPP | 0.01 | 0.01 | 0.01 |
| Average % of credit limit | 85% | 85% | 85% |
| Interest on Prepaid Interest | 3% | 3% | 3% |
| Reduction Term (Months) | 3 | 3 | 3 |
| Max Liability | $31.25 | $62.50 | $125.00 |
| Cost in Points | 3,125 | 6,250 | 12,500 |
| Effective CPP | 0.0085 | 0.0085 | 0.0085 |
| Net Cost | $26.44 | $52.88 | $105.77 |
| Cost savings | $4.81 | $9.62 | $19.23 |

In Table B, an APR reduction of 5% for a term of 3 months can be categorized as a Tier 2 option for potential exchange. As shown, the Tier 2 option can be applied (actually or for estimation) to a plurality of user accounts having different credit limits associated therewith. For example, applying Tier 2 to a credit limit of $2,500 results in a maximum liability of about $31.25 (5%*2500*(3/12 months)=$31.25). Assuming a CPP of 0.01, the application of Tier one to an account with a $2500 credit limit can be valued at 3125 points ($31.25/0.01=3125). Applying the same principles to an account with a credit limit of $5000 results in a valuation of 6250 points. Applying the same principles to an account with a credit limit of $10000 results in a valuation of 12500 points. However, the user of a particular account may only use an average of 85% of the credit limit. As such, the effective CPP could be 0.0085 rather than 0.01, thereby reducing the net cost to the provider of the reduction in APR.

TABLE C
APR Discount Offer Analysis

| | Tier 3 | | |
|---|---|---|---|
| Credit Limit | $2,500 | $5,000 | $10,000 |
| APR Reduction | 10% | 10% | 10% |
| Gross CPP | 0.01 | 0.01 | 0.01 |
| Average % of credit limit | 85% | 85% | 85% |
| Interest on Prepaid Interest | 3% | 3% | 3% |
| Reduction Term (Months) | 3 | 3 | 3 |
| Max Liability | $62.50 | $125.00 | $250.00 |
| Cost in Points | 6,250 | 12,500 | 25,000 |
| Effective CPP | 0.0085 | 0.0085 | 0.0085 |
| Net Cost | $52.88 | $105.77 | $211.54 |
| Cost savings | $9.62 | $19.23 | $38.46 |

In Table C, an APR reduction of 10% for a term of 3 months can be categorized as a Tier 3 option for potential exchange. As shown, the Tier 3 option can be applied (actually or for estimation) to a plurality of user accounts having different credit limits associated therewith. For example, applying Tier 3 to a credit limit of $2,500 results in a maximum liability of about $62.50 (10%*2500*(3/12 months)=$62.50). Assuming a CPP of 0.01, the application of Tier one to an account with a $2500 credit limit can be valued at 6250 points ($62.50/0.01=6250). Applying the same principles to an account with a credit limit of $5000 results in a valuation of 12500 points. Applying the same principles to an account with a credit limit of $10000 results in a valuation of 25000 points. However, the user of a particular account may only use an average of 85% of the credit limit. As such, the effective CPP could be 0.0085 rather than 0.01, thereby reducing the net cost to the provider of the reduction in APR.

In an aspect, such an interest reduction may apply to the different types of value a user can receive from their credit card, whether it be balance transfer interest rate, cash advance interest rate, purchases interest rate, or any other interest rate that is associated with a credit card product. In another aspect, segmentation of users that can receive an interest rate modification can depend on one or more of, customer insights, impact assessment, propensity modeling, cross-selling analysis, critical lag, transaction data, customer habits, customer preferences, account attributes, or any third party data or information. The interest modification can be used as a bonus incentive. In other words, a provider can encourage a card holder to engage in a specific behavior (e.g., spend more in a given time period), and if the card holder does so, the card holder is rewarded with a modification on their annual percentage rate for 6 months.

Another opportunity to use this reduction would be in the case of a “surprise and delight.” This is a reward that is given by a bank to a card holder for no reason what so ever, but is done to help establish a positive image of the bank, build a stronger relationship between the card holder and the bank, and to inspire loyalty and pride with that bank. An example of a “surprise and delight” is that a bank could surprise a card holder with this APR reduction on his/her birthday or perhaps the anniversary date of the member receiving the card. The bank applies the APR reduction for one year starting on the card holder's birthday and ending one year later.

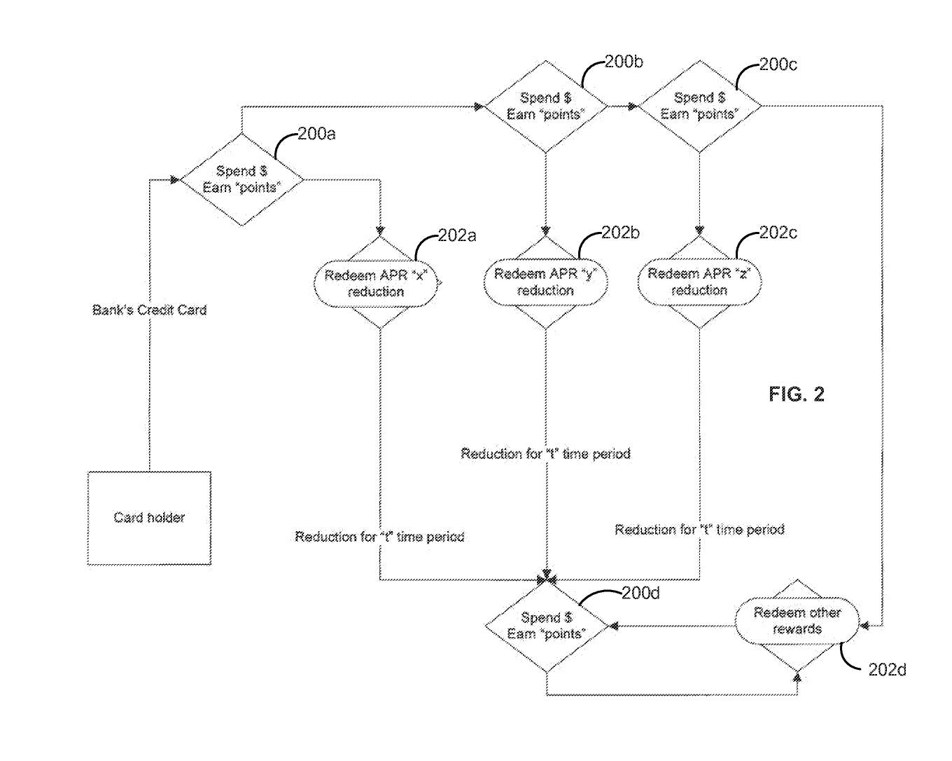

FIG. 2 illustrates a method of implementing a loyalty program. In an aspect, a user can spend money (e.g., via loyalty card, credit card, or tracking mechanism) in order to earn reward currency (e.g., points), at 200a, 200b, 200c, 200d. As reward currency is accumulated, the user can choose to redeem the reward currency. The reward currency can have an exchangeable value that can be associated with one or more options 202a, 202b, 202c, 202d for redemption. As an example, the user can exchange different amounts of exchangeable value for different APR modification (“x %”, “y %”, and “z %,” which can represent different percentages). In certain aspects, in order to have enough exchangeable value to redeem a greater APR modification, the user may have to spend more money. As a further example, the user can exchange reward currency for other items such as gift cards, merchandise, travel, cash back, etc., at 202d. If the user redeems reward currency for one of the APR reductions, then an APR associated with a user account (e.g., account profile) can be reduced for a “t” time period (e.g., 1 year, 2 cycles, 3 months). The user can then continue to spend money and earn reward currency.

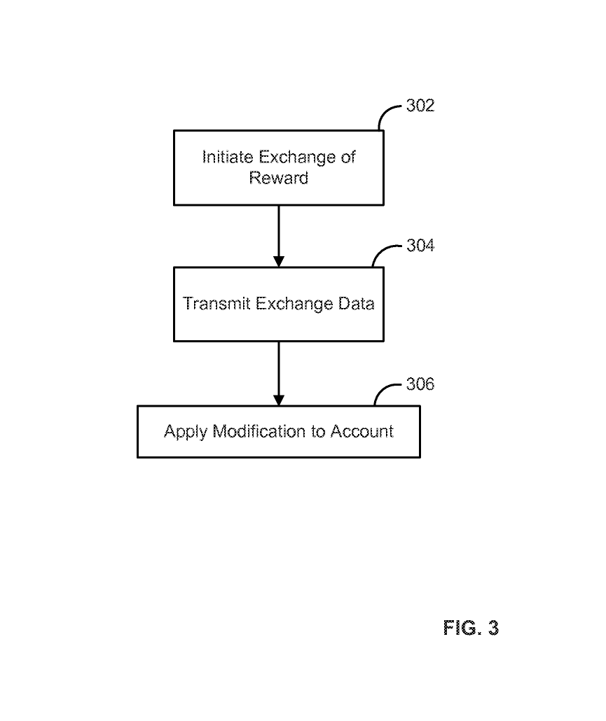

FIG. 3 illustrates a data flow relating to the exchange of reward currency for a modification to an account profile. In an aspect, once the user initiates an exchange of reward currency for a modification (at 302), data relating to the exchange is sent to a provider of the account being modified (e.g., or third party processor), at 304. Such data can comprise user information, account information, duration of the modification, and/or the amount of the modification. In an aspect, the data can be processed by a third party on behalf of a provider of the account profile. Such data can be used to apply the actual modification to the account (e.g., account profile), at 306. In an aspect, the data can facilitate the automatic adjustment to one or more parameters relating to the account or profile. In an aspect, the parameters can comprise one or more of a payment cycle, an interest rate, a due date, deferred payment window, and payment forbearance window. Other parameters relating to a user or account can be modified in exchange for redeeming reward points.

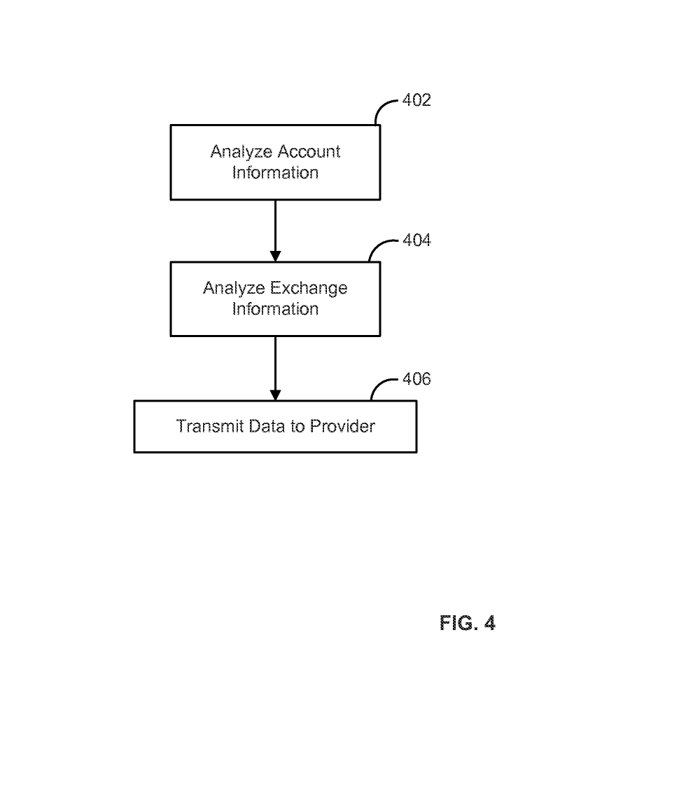

FIG. 4 illustrates a flow diagram relating to the exchange of reward currency for value. At 402, account information can be analyzed to determine whether a user is eligible for a requested exchange (e.g., modification). Such a determination can be based on customer insights, transaction data, account attributes, and/or third party data. At 404, proposed exchange information can be analyzed and/or configured. In an aspect, the type of exchange (e.g., profile modification, gift card, products, etc.) can be determined. In another aspect, one or more of a duration, amount of modification, fixed amount or tiered amount, and/or automation/manual implementation can be determined. At 406, data can be transmitted to the provider (e.g., financial institution, bank, third party processor), or anyone else whose involvement with these data is necessary to implement the exchange. This redemption will allow card holders to use points in order to modify the APR they are paying on their credit card by a set percentage. Cost to the card holder in points can be calculated by multiplying the reduction in APR and the credit limit. The cost to the card holder can be equal to the maximum possible liability the provider could incur assuming that every card holder that redeemed for this item was at 100% of their credit limit for the applied time period.

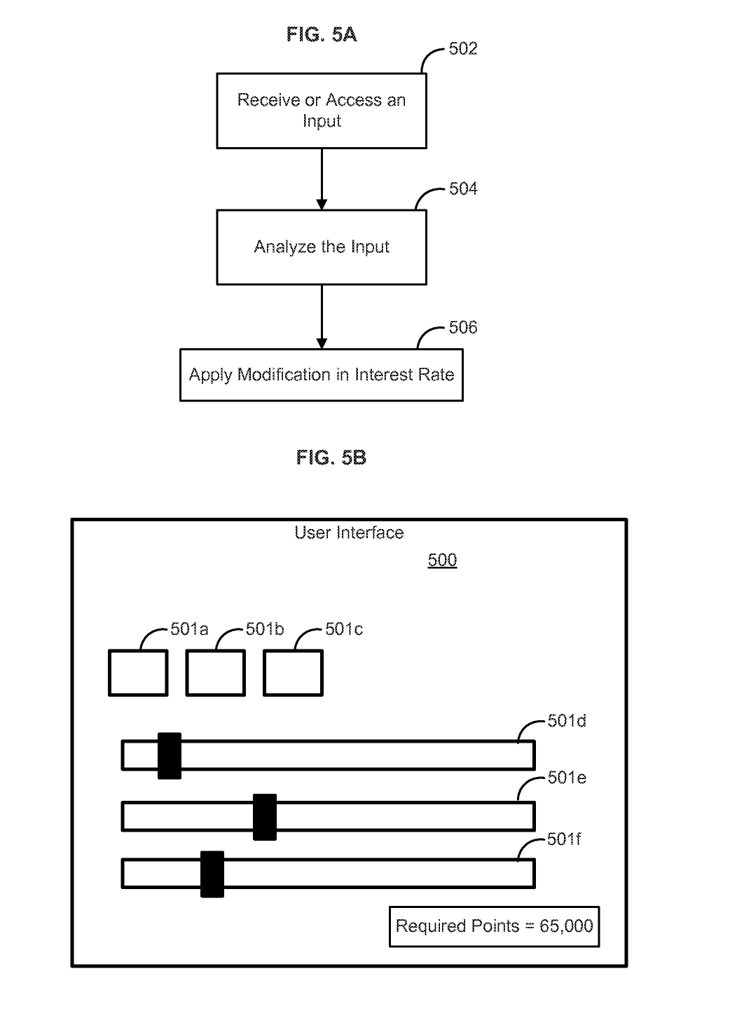

FIG. 5A illustrates a method for redeeming loyalty for value. In step 502, an input can be received or accessed. The input can be received via a communication network such as a computer network, cellular network, telephone network, local area network and/or wide area network (e.g., the Internet). The input can relate to one or more of a loyalty program and a user account. The input can comprise an exchangeable value. As an example, the exchangeable value can comprise one or more loyalty points.

In an aspect, the input can be received via a user interface such as the user interface 500 illustrated in FIG. 5B, for example. As shown, the user interface 500 can comprise one or more input mechanisms 501a, 501b, 501c, 501d, 501e, 501f such as slider bars, input fields, icons, selectable elements, menus, overlays, and the like. In an aspect, each of the input mechanisms can be associated with an input parameter such as a payment cycle, an interest rate, a due date, deferred payment window, and payment forbearance window. In another aspect, as one or more of the input mechanisms 501a, 501b, 501c, 501d, 501e, 501f are configured, a cost (e.g., required exchangeable value) can be calculated based on the configuration of the input mechanism(s) 501a, 501b, 501c, 501d, 501e, 501f. As an example, a user may use one of the input mechanisms 501a, 501b, 501c, 501d, 501e, 501f to designate a desired reduction in APR of 5% and the user may use another of the input mechanism 501a, 501b, 501c, 501d, 501e, 501f to designate a duration of 12 months. Accordingly, a required exchangeable value can be calculated based on a 5% reduction in APR over 12 months, can be applied to configure one or more of a payment cycle, an interest rate, a due date, deferred payment window, and payment forbearance window. Other parameters relating to a user or account can be modified in exchange for redeeming reward points.

Returning to FIG. 5A, in step 504, the input can be analyzed. In an aspect, the input can be analyzed based upon an instruction set. The instruction set can comprise processor executable instructions for automatically determining a modification (e.g., increase or decrease) in interest rate. The determination can be based upon the exchangeable value associated with the input. Determining a modification in interest rate can comprise retrieving a modification in the interest rate, for example, from a stored table of values. Determining a modification in interest rate can comprise calculating a modification in the interest rate based upon a credit limit associated with the user account. Determining a modification in interest rate can comprise calculating a modification in the interest rate based upon a liability to a provider associated with the user account.

In step 506, the modification in interest rate can be applied to a current interest rate. The current interest rate can be associated with the user account such as a financial account. The modification in interest rate can be applied to the current interest rate for a fixed period of time. As an example, the fixed period of time can be based upon the exchangeable value.

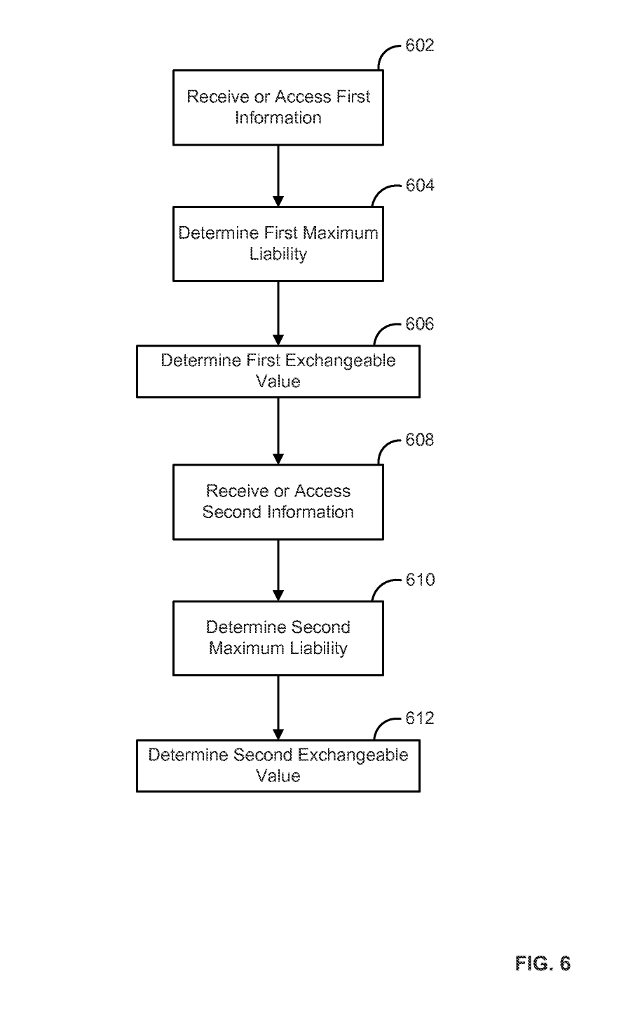

FIG. 6 illustrates a method of managing a loyalty program. In step 602, first information can be received or accessed. The first information can relate to a financial account such as a credit account or investment account associated with a user. The financial account can have an interest rate (e.g., APR) associated therewith. In an aspect, the first information comprises a credit limit. Other information relating to the financial account can be included as the first information such as spending habits, payment history, balance, and the like.

In step 604, a first maximum liability can be determined. In an aspect, the first maximum liability can be based on one or more of the first information and a first fixed modification of the interest rate associated with the credit account. In another aspect, determining maximum liability can comprise calculating an estimated cost of applying the first fixed modification to the credit account for a fixed period of time.

In step 606, a first exchangeable value can be determined. In an aspect, the first exchangeable value can relate to a loyalty program. In another aspect, the first exchangeable value can be based on the first maximum liability. In a further aspect, the first exchangeable value can be redeemable to facilitate the application of the first fixed modification to the interest rate associated with the credit account.

In step 608, second information can be received or accessed. The second information can relate to a financial account such as a credit account or investment account associated with a user. The financial account can have an interest rate (e.g., APR) associated therewith. In an aspect, the second information can comprise a credit limit. As an example, the second information can be different from the first information. Other information relating to the financial account can be included in the second information such as spending habits, payment history, balance, and the like. The second information can relate to the same account as the first information.

In step 610, a second maximum liability can be determined. In an aspect, the second maximum liability can be based on one or more of the second information and a first fixed modification of the interest rate associated with the credit account. In another aspect, determining maximum liability can comprise calculating an estimated cost of applying the first fixed modification to the credit account for a fixed period of time. In a further aspect, the second maximum liability can be based on one or more of the first information, second information, and a second fixed modification of the interest rate associated with the financial account.

In step 612, a second exchangeable value can be determined. In an aspect, the second exchangeable value can relate to a loyalty program. As an example, the second exchangeable value can be different from the first exchangeable value. In another aspect, the second exchangeable value can be based on the second maximum liability. In a further aspect, the second exchangeable value can be redeemable to facilitate the application of the first fixed modification to the interest rate associated with the credit account. The second exchangeable value can be redeemable to facilitate the application of the second fixed modification to the interest rate associated with the financial account.

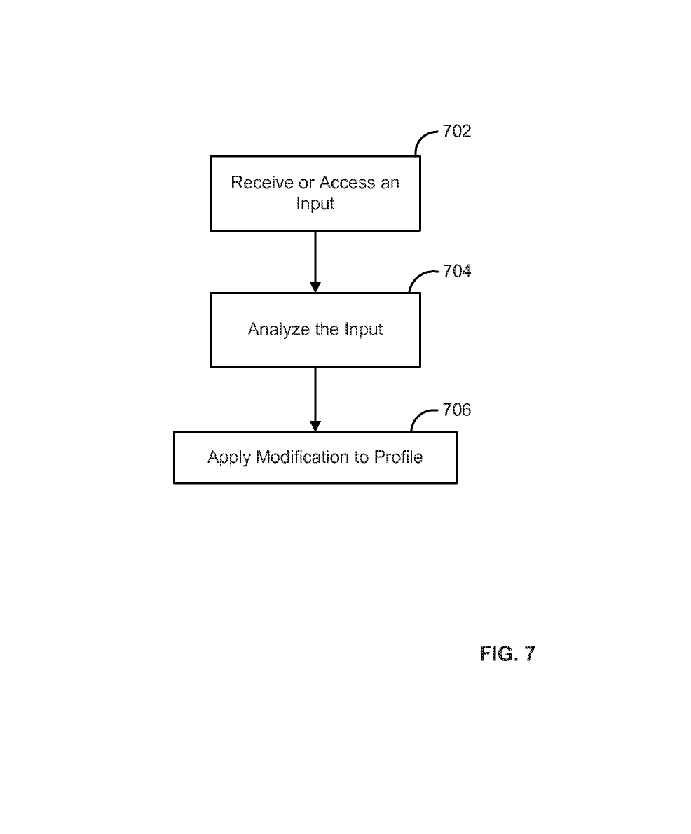

FIG. 7 illustrates a method for redeeming loyalty for value. In step 702, an input can be received or accessed. The input can be received via a communication network such as a computer network, cellular network, telephone network, local area network and/or wide area network (e.g., the Internet). The input can relate to one or more of a loyalty program and a user account. The input can comprise an exchangeable value. As an example, the exchangeable value can comprise one or more loyalty points.

In step 704, the input can be analyzed. In an aspect, the input can be analyzed based upon an instruction set. The instruction set can comprise processor executable instructions for automatically determining a modification (e.g., increase or decrease) in interest rate. The determination can be based upon the exchangeable value associated with the input. Determining a modification in interest rate can comprise retrieving a modification in the interest rate, for example, from a stored table of values. Determining a modification in interest rate can comprise calculating a modification in the interest rate based upon a credit limit associated with the user account. Determining a modification in interest rate can comprise calculating a modification in the interest rate based upon a liability to a provider associated with the user account.

In step 706, the modification can be applied to the profile associated with the user account. In an aspect, the profile can comprise one or more of a payment cycle, an interest rate, a due date, deferred payment window, and payment forbearance window. In another aspect, the modification can be applied to configure one or more of a payment cycle, an interest rate, a due date, deferred payment window, and payment forbearance window. Other parameters relating to a user or account can be modified in exchange for redeeming reward points.

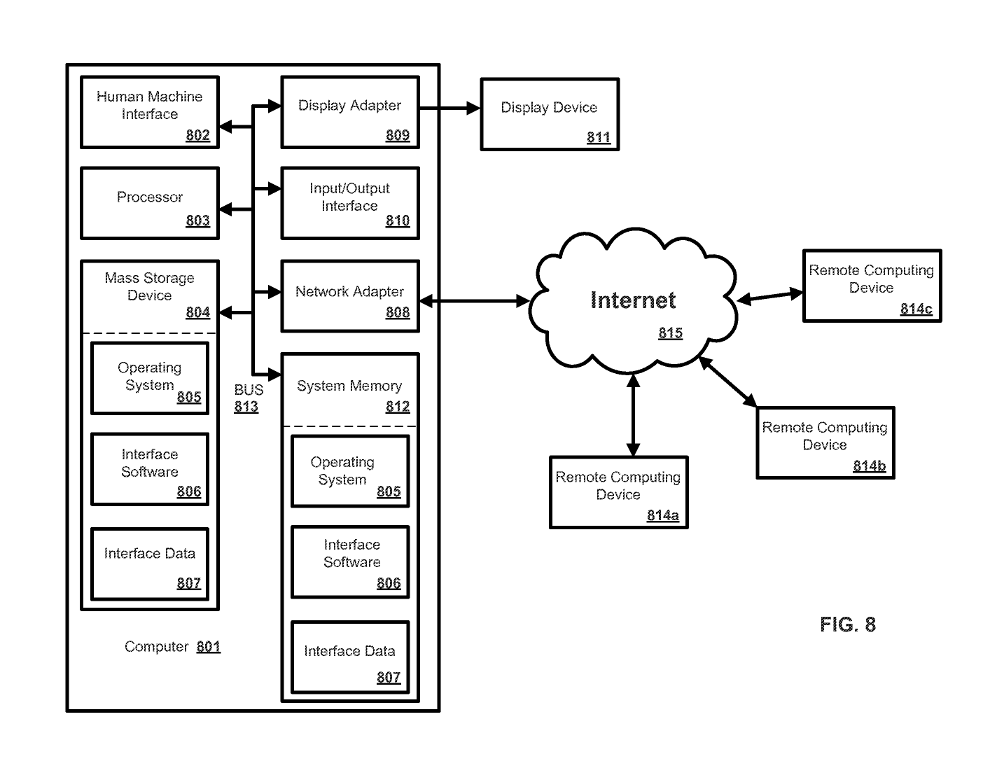

FIG. 8 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 801. The components of the computer 801 can comprise, but are not limited to, one or more processors or processing units 803, a system memory 812, and a system bus 813 that couples various system components including the processor 803 to the system memory 812. In the case of multiple processing units 803, the system can utilize parallel computing.

The system bus 813 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 813, and all buses specified in this description can also be implemented over a wired or wireless network connection and each of the subsystems, including the processor 803, a mass storage device 804, an operating system 805, interface software 806, interface data 807, a network adapter 808, system memory 812, an Input/Output Interface 810, a display adapter 809, a display device 811, and a human machine interface 802, can be contained within one or more remote computing devices 814a,b,c at physically separate locations, connected through buses of this form, in effect implementing a fully distributed system.

The computer 801 typically comprises a variety of computer readable media. Exemplary readable media can be any available media that is accessible by the computer 801 and comprises, for example and not meant to be limiting, both volatile and non-volatile media, removable and non-removable media. The system memory 812 comprises computer readable media in the form of volatile memory, such as random access memory (RAM), and/or non-volatile memory, such as read only memory (ROM). The system memory 812 typically contains data such as interface data 807 and/or program modules such as operating system 805 and interface software 806 that are immediately accessible to and/or are presently operated on by the processing unit 803.

In another aspect, the computer 801 can also comprise other removable/non-removable, volatile/non-volatile computer storage media. By way of example, FIG. 8 illustrates a mass storage device 804 which can provide non-volatile storage of computer code, computer readable instructions, data structures, program modules, and other data for the computer 801. For example and not meant to be limiting, a mass storage device 804 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 804, including by way of example, an operating system 805 and interface software 806. Each of the operating system 805 and interface software 806 (or some combination thereof) can comprise elements of the programming and the interface software 806. Interface data 807 can also be stored on the mass storage device 804. Interface data 807 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 801 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 803 via a human machine interface 802 that is coupled to the system bus 813, but can be connected by other interface and bus structures, such as a parallel port, game port, an IEEE 1394 Port (also known as a Firewire port), a serial port, or a universal serial bus (USB).

In yet another aspect, a display device 811 can also be connected to the system bus 813 via an interface, such as a display adapter 809. It is contemplated that the computer 801 can have more than one display adapter 809 and the computer 801 can have more than one display device 811. For example, a display device can be a monitor, an LCD (Liquid Crystal Display), or a projector. In addition to the display device 811, other output peripheral devices can comprise components such as speakers (not shown) and a printer (not shown) which can be connected to the computer 801 via Input/Output Interface 810. Any step and/or result of the methods can be output in any form to an output device. Such output can be any form of visual representation, including, but not limited to, textual, graphical, animation, audio, tactile, and the like.

The computer 801 can operate in a networked environment using logical connections to one or more remote computing devices 814a,b,c. By way of example, a remote computing device can be a personal computer, portable computer, a server, a router, a network computer, a peer device or other common network node, and so on. Logical connections between the computer 801 and a remote computing device 814a,b,c can be made via a local area network (LAN) and a general wide area network (WAN). Such network connections can be through a network adapter 808. A network adapter 808 can be implemented in both wired and wireless environments. Such networking environments are conventional and commonplace in offices, enterprise-wide computer networks, intranets, and the Internet 815.

For purposes of illustration, application programs and other executable program components such as the operating system 805 are illustrated herein as discrete blocks, although it is recognized that such programs and components reside at various times in different storage components of the computing device 801, and are executed by the data processor(s) of the computer. An implementation of interface software 806 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

The present systems and methods enables a provider (e.g., bank) to receive interest in an “up front” manner, such as in the form of liability money recognizable as sales. If a card holder keeps making same payments, the balance gets paid off faster thus freeing more credit to spend and make interchange. As such, the card holder is likely to place greater perceived value on the APR reduction than the actual calculated savings.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A data management system comprising:
a user interface configured to receive an input, wherein the input comprises an exchangeable value associated with a loyalty program and a user account; and
a processor in communication with the user interface to receive the input therefrom, the processor configured to analyze the input based upon an instruction set and to generate feedback in response to the analysis of the input, wherein the feedback comprises a modification in an interest rate associated with the user account.

2. The system of claim 1, wherein the user interface comprises a graphical user interface.

3. The system of claim 1, wherein the exchangeable value comprises one or more loyalty points.

4. The system of claim 1, wherein the instruction set comprises processor executable instructions for automatically retrieving a modification in the interest rate based on the exchangeable value.

5. The system of claim 1, wherein the instruction set comprises processor executable instructions for automatically calculating a modification in the interest rate based upon a credit limit associated with the user account.

6. The system of claim 1, wherein the instruction set comprises processor executable instructions for automatically calculating a modification in the interest rate based upon a liability to a provider associated with the user account.

7. The system of claim 6, wherein the provider is a financial provider.

8. The system of claim 1, wherein the feedback further comprises a fixed period of time during which the modification in the interest rate is applied.

9. The system of claim 1, wherein the modification is one of an increase or decrease in the interest rate.

10. A method for redeeming loyalty for value comprising:
receiving an input relating to a loyalty program and a user account, wherein the input comprises an exchangeable value;
analyzing, by a processor, the input based upon an instruction set, wherein the instruction set comprises processor executable instructions for automatically determining a modification in interest rate based upon the exchangeable value; and
applying the modification in interest rate to a current interest rate associated with the user account.

11. The method of claim 10, wherein the input is received via a communication network.

12. The method of claim 10, wherein the exchangeable value comprises one or more loyalty points.

13. The method of claim 10, wherein determining a modification in interest rate comprises retrieving a modification in the interest rate.

14. The method of claim 10, wherein the instruction set further comprises processor executable instructions for automatically calculating a modification in the interest rate based upon a credit limit associated with the user account.

15. The method of claim 10, wherein the instruction set further comprises processor executable instructions for automatically calculating a modification in the interest rate based upon a liability to a provider associated with the user account.

16. The method of claim 10, wherein the modification in interest rate is applied to the current interest rate for a fixed period of time, and wherein the fixed period of time is based upon the exchangeable value.

17. The method of claim 10, wherein the modification is one of an increase or decrease in the interest rate.

18. A method comprising:
receiving first information relating to a credit account associated with a user, wherein the credit account has an interest rate associated therewith;
determining, by a processor, a first maximum liability based on the first information and a first fixed modification of the interest rate associated with the credit account; and
determining, by the processor, a first exchangeable value relating to a loyalty program based on the first maximum liability, wherein the first exchangeable value is redeemable to facilitate the application of the first fixed modification to the interest rate associated with the credit account.

19. The method of claim 18, wherein the first information comprises a credit limit.

20. The method of claim 18, wherein determining maximum liability comprises calculating an estimated cost of applying the first fixed modification to the credit account for a fixed period of time.

21. The method of claim 18, further comprising:
receiving second information relating to the credit account;
determining, by the processor, a second maximum liability based on the second information and the first fixed modification of the interest rate associated with the credit account; and
determining, by the processor, a second exchangeable value relating to the loyalty program based on the maximum liability, wherein the second exchangeable value is redeemable to facilitate the application of the first fixed modification to the interest rate associated with the credit account.

22. The method of claim 18, further comprising:
determining, by the processor, a second maximum liability based on the first information and a second fixed modification of the interest rate associated with the credit account;
determining, by the processor, a second exchangeable value relating to the loyalty program based on the second maximum liability, wherein the second exchangeable value is different from the first exchangeable value, and wherein the second exchangeable value is redeemable to facilitate the application of the second fixed modification to the interest rate associated with the credit account.

23. A method for redeeming loyalty for value comprising:
receiving an input relating to a loyalty program and a user account, wherein the input comprises an exchangeable value and the user account has a profile associated therewith;
analyzing, by a processor, the input based upon an instruction set, wherein the instruction set comprises processor executable instructions for automatically determining a modification to the profile based upon the exchangeable value; and
applying the modification to the profile associated with the user account.

24. The method of claim 23, wherein the input is received via a communication network.

25. The method of claim 23, wherein the exchangeable value comprises one or more loyalty points.

26. The method of claim 23, wherein the profile comprises one or more of a payment cycle, an interest rate, a due date, deferred payment window, and payment forbearance window.
